(19) United States
(12) Patent Application Publication
(10) Pub. No.: US 2020/0334722 A1
(43) Pub. Date: Oct. 22, 2020

(54) SERVER AND BATTERY LENDING METHOD

(71) Applicant: TOYOTA JIDOSHA KABUSHIKI KAISHA, Toyota-shi (JP)

(72) Inventors: Yasuhide KURIMOTO, Kasugai-shi (JP); Hideaki MIYAKE, Nisshin-shi (JP); Junta IZUMI, Nagoya-shi (JP)

(21) Appl. No.: 16/839,135

(22) Filed: Apr. 3, 2020

(30) Foreign Application Priority Data
Apr. 22, 2019 (JP) 2019-080792
Feb. 26, 2020 (JP) 2020-030411

(51) Int. Cl. G06Q 30/02; G06Q 30/06; G06Q 10/00; H02J 7/00; B60L 53/66; B60L 58/12

(52) U.S. Cl. CPC G06Q 30/0284; G06Q 30/0645; B60L 58/12; H02J 7/0049; B60L 53/665; G06Q 10/20

(57) ABSTRACT

A fee charging server manages a lending fee (a lease unit price) paid by a user for lending a battery mounted on a vehicle for traveling. The fee charging server includes a communication module that communicates with the vehicle, and an application server that collects a full charge capacity (a capacity retention ratio) of the battery from the vehicle via the communication module and determines the lending fee according to the collected full charge capacity.

This nonprovisional application is based on Japanese Patent Application Nos. 2019-080792 and 2020-030411 filed on Apr. 22, 2019 and Feb. 26, 2020, respectively, with the Japan Patent Office, the entire contents of which are hereby incorporated by reference.

### BACKGROUND

### Field

The present disclosure relates to a server and a battery lending method, and more particularly to a technique for lending a battery mounted on a vehicle for traveling.

### Description of the Background Art

It is conceivable to lend to a user a battery mounted on a vehicle for traveling. Only a battery may be lent to a user who owns a vehicle, or a battery may be lent to a user together with a vehicle (a portion other than the battery).

For example, according to a method disclosed in Japanese Patent Laying-Open No. 2002-291110, an amount of electric power charged to a battery (an amount of commercial power consumed for charging the battery) or an amount of electric power discharged from the battery is measured as data of use of the battery. Then, a lending fee is calculated according to the data (see Japanese Patent Laying-Open No. 2002-291110, paragraphs [0029] and [0043]).

### SUMMARY

Generally, a battery deteriorates with time or as it is used. A battery's deterioration can affect the convenience of the vehicle for the user. However, Japanese Patent Laying-Open No. 2002-291110 only describes calculating a lending fee in accordance with an amount of electric power charged/discharged to/from a battery, and does not particularly consider the battery's deterioration in calculating the lending fee.

The present disclosure has been made in order to solve the above-described problem, and an object of the present disclosure is to determine a fee for lending the battery with the battery's deterioration considered.

(1) According to one aspect of the present disclosure, a server manages a fee unit price paid by a user for lending a battery mountable on a vehicle for traveling. The server comprises: a communication device that communicates with the vehicle; and a processor that collects the battery's full charge capacity from the vehicle via the communication device and determines the lending fee according to the collected full charge capacity.

(2) The server further comprises a fee charging device that charges the user with the lending fee determined by the processor after the battery is lent for a predetermined period of time or after the vehicle travels a predetermined distance.

As the battery deteriorates, and accordingly, its full charge capacity decreases, a distance that the vehicle can travel with electric power stored in the battery (i.e., an EV traveling distance) decreases. Further, as the full charge capacity decreases, the battery may be charged more frequently, and the user takes extra time and effort for charging the battery. Therefore, it can be said that the vehicle is less convenient for the user as the full charge capacity decreases. According to the above configurations (1) and (2), a battery lending fee can be determined with a full charge capacity reflecting the battery's deterioration taken into consideration.

(3) The processor provides the user via the communication device with the lending fee determined by the processor.

The lending fee can change as time elapses or the vehicle travels. According to the above configuration (3), the user can be informed of the lending fee (that is, the latest fee information).

(4) The processor decreases the lending fee as the battery's full charge capacity decreases.

According to the above configuration (4), the lending fee is determined to be lower as the battery's full charge capacity decreases (or as the battery's capacity retention ratio decreases in an example described later). Then, the user only has to pay a fee corresponding to the battery's performance, and the user's dissatisfaction is less likely to accumulate, which can suppress reduction of the user's satisfaction.

(5) The processor keeps the lending fee after the battery's full charge capacity falls below a predetermined amount.

(6) When the battery's full charge capacity falls below the predetermined amount, the processor sets the lending fee to be higher than when the battery's full charge capacity exceeds the predetermined amount.

According to the above configurations (5) and (6), as the battery's full charge capacity decreases, the lending fee will no longer be decreased or, in contrast, the lending fee is determined to be higher. When the lending fee is increased while the battery's full charge capacity is decreasing, the user will pay a lending fee higher than an amount of money that is commensurate with the value of the battery. Hence, the user is motivated to return the currently used battery to the leaser (or a lease company or the like) for example for exchanging the battery with a new battery. The leaser can thus collect the battery before it excessively deteriorates.

(7) The processor provides the user with first information about when the lending fee will be changed before the lending fee is changed.

According to the above configuration (7), providing the user beforehand with the first information about when the lending fee will be changed can avoid a situation in which the lending fee is suddenly changed. Thereby, user satisfaction can be improved.

(8) The processor provides the user with second information for increasing an electric vehicle (EV) travel distance for which the vehicle can travel using power stored in the battery, determined based on a status of use of the battery by the user.

(9) The second information is information about a recommended charging frequency of the battery, determined based on a travel distance per day of the vehicle and the EV travel distance.

(10) The second information is information about a recommended charging manner of the battery including timer charging performed according to a time schedule, determined based on a time for which the battery is left with an SOC of the battery being higher than a reference value.

According to the above features (8) to (10), by providing the user with the second information about the recommended charging frequency or the recommended charging manner, the user can avoid setting the charging frequency to be unnecessarily high, or can utilize timer charging for charging. Although details will be described later, progress of deterioration of the battery can be thereby suppressed, which can decrease the lending fee for the battery. As a result, user satisfaction can be improved.

(11) According to another aspect of the present disclosure, a battery lending method lends to a user a battery mountable on a vehicle for travelling. The battery lending method comprises: collecting the battery's full charge capacity from the vehicle; and, according to the full charge capacity collected, determining a lending fee to be paid by the user for lending the battery.

According to the method of the configuration (11), as well as the configuration of (1), a battery lending method can be determined while considering a full charge capacity reflecting a battery's deterioration affecting the convenience of a vehicle.

The foregoing and other objects, features, aspects, and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a battery distribution model in an embodiment.

FIG. 2 is a diagram schematically showing an overall configuration of a battery lease system in accordance with an embodiment.

FIG. 3 is a diagram showing configurations of a vehicle and a fee charging server in more detail.

FIG. 4 is a diagram showing an example of how a battery deteriorates.

FIG. 5 is a diagram for illustrating a fee plan A.

FIG. 6 represents a relationship between a capacity retention ratio of a battery and a lease unit price for the battery in fee plan A.

FIG. 7 represents a relationship between a capacity retention ratio of a battery and a lease unit price for the battery in a fee plan B.

FIG. 8 represents a relationship between a capacity retention ratio of a battery and a lease unit price for the battery in a fee plan C.

FIG. 9 is a diagram for illustrating a difference between capacity retention ratios of batteries in two vehicles.

FIG. 10 is a diagram for illustrating an effect of a battery's SOC on the battery's capacity retention ratio.

FIG. 11 is a diagram for illustrating an effect of a battery's temperature on the battery's capacity retention ratio.

FIG. 12 is a diagram for illustrating an effect of a battery's load on the battery's capacity retention ratio.

FIG. 13 is a flowchart of a process for leasing a battery according to a first embodiment.

FIG. 14 is a conceptual view showing an example of a data structure of battery information.

FIG. 15 is a conceptual view showing an example of a data structure of lease contract information.

FIG. 16 is a flowchart of a process for leasing a battery according to a second embodiment.

FIG. 17 is a flowchart of one example of an information provision process.

### DESCRIPTION OF THE PREFERRED EMBODIMENTS

Hereinafter, the present embodiment will be described in detail with reference to the drawings. It should be noted that identical or corresponding parts in the drawings will be designated by the same reference numerals, and the description thereof will not be repeated.

In the present disclosure, a battery is a battery assembly including a plurality of modules (also referred to as a plurality of blocks). The plurality of modules may be connected in series, or may be connected in parallel. Each of the plurality of modules includes a plurality of cells (unit cells) connected in series or in parallel.

In the present embodiment, used batteries are collected from a plurality of vehicles, and the collected batteries are recycled. In the following, a manner of distribution from collection of the used batteries to sale of the recycled batteries is referred to as a “battery distribution model”.

Generally, “recycle” of a battery is broadly categorized into reuse, rebuild, and resource recycle. In the case of reuse, collected batteries are subjected to necessary shipment inspection and shipped as they are as reuse products. In the case of rebuild, collected batteries are once disassembled to modules, for example. Then, among the disassembled modules, modules which can be used after reconditioning (which may be modules which can be used as they are) are combined to manufacture a new battery. Newly manufactured batteries are subjected to shipment inspection and shipped as rebuilt products. In contrast, in the case of resource recycle, renewable materials are taken out of each cell and hence collected batteries are not used as other batteries. “Recycle” of a battery in the present disclosure means reuse or rebuild of a battery. It should be noted that, in the case of rebuild, at least one of a plurality of modules constituting a battery is replaced with another module (replacement module). Although the replacement module is basically a recyclable module taken out of a collected battery, it may be a new module.

### First Embodiment

<Battery Distribution Model>

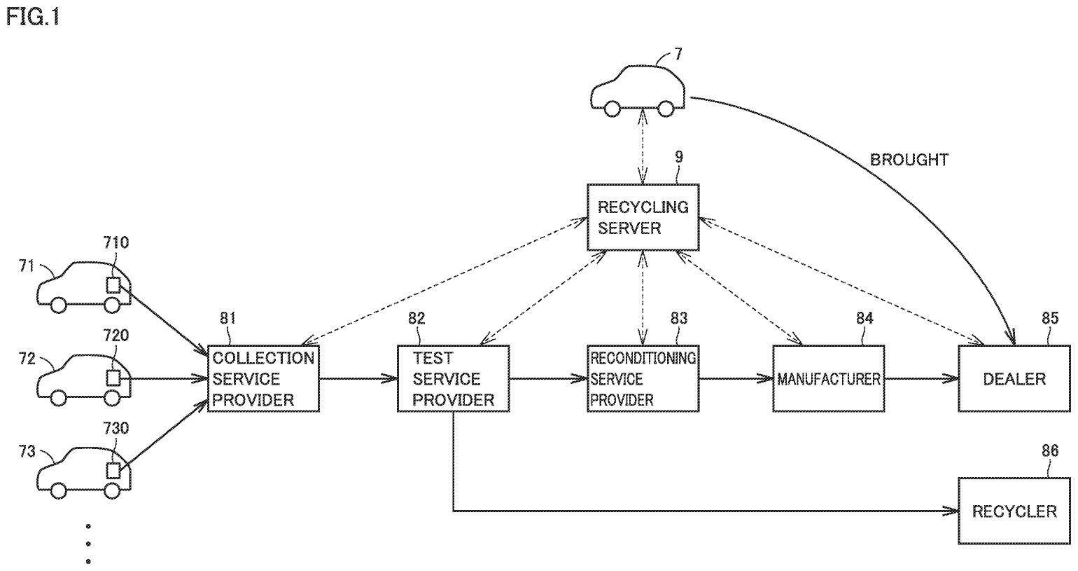

FIG. 1 is a view showing a battery distribution model in an embodiment. Referring to FIG. 1, in the battery distribution model, used batteries 710 to 730 mounted on vehicles 71 to 73, respectively, are collected. Collected batteries 710 to 730 are recycled through a process handled by a collection service provider 81, a test service provider 82, a reconditioning service provider 83, a manufacturer 84, and a dealer 85 (or a recycler 86). In this process, a variety of information about the batteries is managed by a recycling server 9. Then, a battery mounted on a vehicle 7 of a certain user is replaced with a recycled battery.

More specifically, collection service provider 81 collects used batteries 710 to 730 from vehicles 71 to 73. It should be noted that, although FIG. 1 shows only three vehicles due to space restriction, batteries are actually collected from a larger number of vehicles. Collection service provider 81 disassembles the collected batteries and takes out a plurality of modules from the batteries. Each module is provided with identification information (ID) for identifying the module, and information on each module is managed by recycling server 9. Therefore, collection service provider 81 transmits the ID of each module taken out of a battery to recycling server 9, using a terminal (not shown).

Test service provider 82 tests performance of each module collected by collection service provider 81. Specifically, test service provider 82 tests characteristics of each collected module. For example, test service provider 82 tests electrical characteristics such as a full charge capacity, a resistance value, an open circuit voltage (OCV), and a state of charge (SOC). Then, test service provider 82 classifies the modules into recyclable modules and non-recyclable modules based on test results, passes the recyclable modules to reconditioning service provider 83 and the non-recyclable modules to recycler 86. It should be noted that the test result of each module is transmitted to recycling server 9, using a terminal (not shown) of test service provider 82.

Reconditioning service provider 83 performs processing for reconditioning a module determined as recyclable by test service provider 82. By way of example, reconditioning service provider 83 restores a full charge capacity of the module by charging the module to an overcharged state. However, for a module determined as having less performance degradation in the test by test service provider 82, the reconditioning processing performed by reconditioning service provider 83 may be skipped. The result of reconditioning of each module is transmitted to recycling server 9, using a terminal (not shown) of reconditioning service provider 83.

Manufacturer 84 manufactures a battery, using modules reconditioned by reconditioning service provider 83. In the present embodiment, information for manufacturing a battery (assembly information) is generated by recycling server 9 and transmitted to a terminal (not shown) of manufacturer 84. According to the assembly information, manufacturer 84 manufactures (rebuilds) a battery of vehicle 7 by replacing a module included in the battery of vehicle 7.

Dealer 85 sells the battery manufactured by manufacturer 84 for vehicle use or for stationary use in a house or the like. In the present embodiment, vehicle 7 is brought to dealer 85 and dealer 85 replaces the battery of vehicle 7 with a reuse product or a rebuilt product manufactured by manufacturer 84.

Recycler 86 disassembles a module determined as being non-recyclable by test service provider 82 for reclamation for use as new cells or as source materials for other products.

It should be noted that, although collection service provider 81, test service provider 82, reconditioning service provider 83, manufacturer 84, and dealer 85 are service providers different from one another in FIG. 1, classification of the service providers is not limited as such. For example, a single service provider may serve as test service provider 82 and reconditioning service provider 83. Alternatively, collection service provider 81 may be divided into a service provider which collects batteries and a service provider which disassembles collected batteries. In addition, locations of the service providers and the dealer are not particularly limited. Locations of the service providers and the dealer may be different, or a plurality of service providers or the dealer may be located at the same place.

<Battery Lease System>

In the present embodiment, there is established a system that leases a battery to a user so as to prevent a reduction in the value of the battery and increase the amount of collected recyclable batteries. This system is referred to as a “battery lease system”.

It should be noted that lease and rental are known as transactions in which a party owning an item, such as an apparatus or a facility, lends the item to another. Generally, lease is a transaction in which a lease company purchases an item selected by a person/company as a lessee, and lends the item to the lessee for a relatively long period (usually, for several years). Rental is a transaction in which a rental company lends an item it already owns to a lessee for a period for which the lessee needs the item (usually, for a period shorter than a lease period). Although a description is given below of an example where a battery is leased, the battery may be rented instead of being leased.

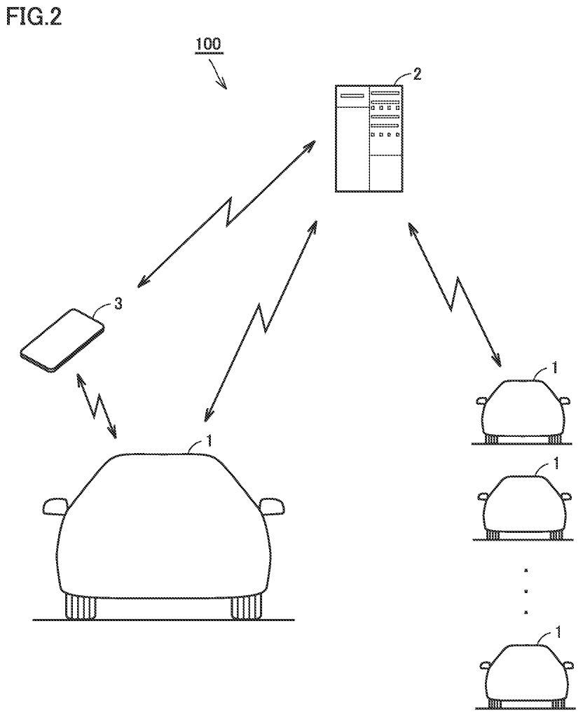

FIG. 2 is a view schematically showing an overall configuration of the battery lease system in accordance with the first embodiment. Referring to FIG. 2, a battery lease system 100 includes a plurality of vehicles 1 and a fee charging server 2. Each of the plurality of vehicles 1 is configured to bidirectionally communicate with fee charging server 2.

In the following, a description is given focusing on one specific vehicle 1 (vehicle 1 on the left side in the drawing) for simplification of the description. This vehicle 1 is also configured to bidirectionally communicate with a smart phone 3 of a user of vehicle 1. Further, fee charging server 2 is also configured to bidirectionally communicate with smart phone 3.

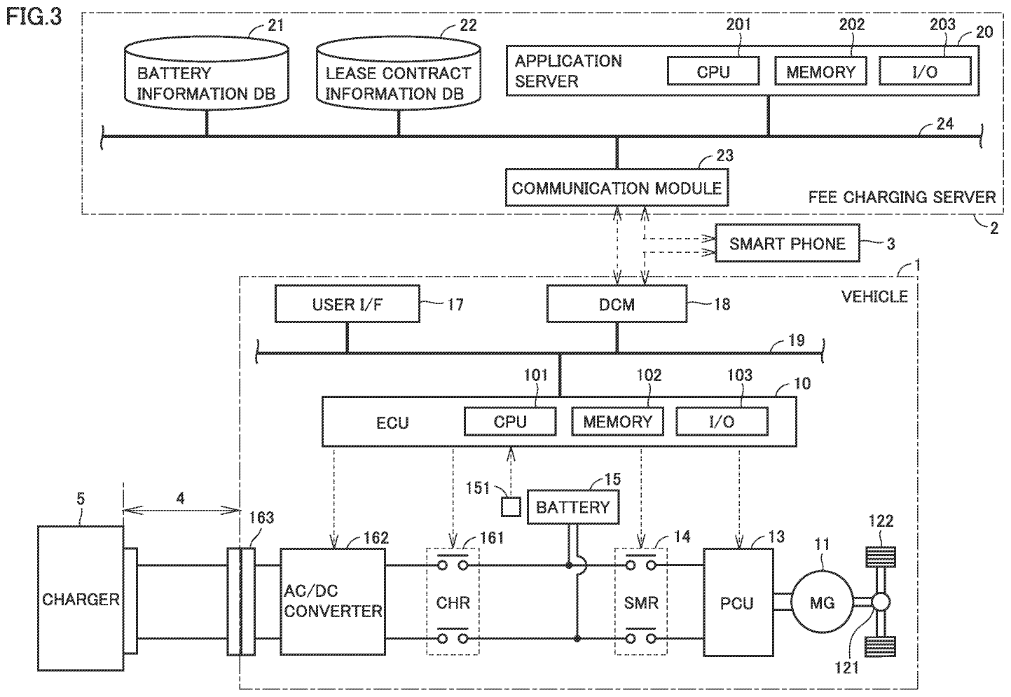

FIG. 3 is a view showing configurations of vehicle 1 and fee charging server 2 in more detail. Referring to FIG. 3, the present embodiment describes an example where vehicle 1 is an electric vehicle. However, vehicle 1 may be another electrically powered vehicle (a hybrid vehicle, a plug-in hybrid vehicle, or a fuel cell vehicle). Vehicle 1 is configured to be electrically connected to a charger 5 outside the vehicle, using a charging cable 4.

Vehicle 1 includes a motor generator 11, a power transmission gear 121, drive wheels 122, a power control unit (PCU) 13, a system main relay (SMR) 14, a battery 15, an inlet 161, an AC/DC converter 162, a charging relay 163, a user interface 17, a data communication module (DCM) 18, a vehicle-mounted network 19, and an electronic control unit (ECU) 10.

Motor generator 11 is an alternating current (AC) rotating electric machine, and is, for example, a permanent magnet-type synchronous motor including a rotor having a permanent magnet embedded therein. The output torque of motor generator 11 is transmitted to drive wheels 122 through power transmission gear 121, to cause vehicle 1 to travel. In addition, during a braking operation of vehicle 1, motor generator 11 can generate electric power using a rotational force of drive wheels 122. The electric power generated by motor generator 11 is converted by PCU 13 into charging power for battery 15.

PCU 13 is configured to include a converter and an inverter (both not shown). PCU 13 converts direct current (DC) power stored in battery 15 into AC power and supplies it to motor generator 11 according to a command from ECU 10. In addition, PCU 13 converts AC power generated by motor generator 11 into DC power and supplies it to battery 15.

SMR 14 is electrically connected to power lines connecting PCU 13 and battery 15. SMR 14 switches supply and interruption of electric power between PCU 13 and battery 15 according to a command from ECU 10.

Battery 15 supplies electric power for generating a drive force for vehicle 1. In addition, battery 15 stores the electric power generated by motor generator 11. Battery 15 is a battery assembly configured to include a plurality of modules. Each of the plurality of modules includes a plurality of cells. In the present embodiment, each cell is a lithium ion secondary battery. It should be noted that, although the electrolyte for the lithium ion secondary battery is a liquid electrolyte, for example, it is not limited to a liquid electrolyte, but may be a polymer electrolyte or an all-solid electrolyte.

Battery 15 is provided with a monitoring unit 151 that monitors the state of battery 15. Specifically, monitoring unit 151 includes a voltage sensor, a current sensor, and a temperature sensor (all not shown). The voltage sensor detects the voltage of battery 15. The current sensor detects a current input/output to/from battery 15. The temperature sensor detects the temperature of battery 15. Each sensor outputs a detection result thereof to ECU 10. ECU 10 calculates an index indicating a state of deterioration of battery 15 based on the detection result from each sensor. This index will be described later.

Inlet 161 is configured such that a charging plug (not shown) of charging cable 4 can be connected thereto.

AC/DC converter 162 is electrically connected to power lines connecting inlet 161 and charging relay 163. AC/DC converter 162 converts AC power supplied from charger 5 through charging cable 4 and inlet 161 into DC power, and outputs it to charging relay 163.

Charging relay 163 is electrically connected to power lines connecting AC/DC converter 162 and battery 15. Charging relay 163 switches supply and interruption of electric power between AC/DC converter 162 and battery 15 according to a command from ECU 10.

It should be noted that the configuration for charging vehicle 1 with the electric power supplied from charger 5 (external charging) is not limited to the configuration shown in FIG. 3. For example, when charger 5 is a charger that supplies DC power (a so-called fast charger), it is not necessary to provide AC/DC converter 162, or a DC/DC converter (not shown) may be provided instead of AC/DC converter 162.

User interface 17 is configured to provide the user with a variety of information about vehicle 1, and receive various operations by the user. User interface 17 is implemented, for example, by a touch panel-equipped monitor of a car navigation system.

DCM 18 is configured to wirelessly bidirectionally communicate with fee charging server 2. DCM 18 is also configured to wirelessly communicate with smart phone 3 of the user of vehicle 1.

Vehicle-mounted network 19 is a wired network such as Controller Area Network (CAN), for example, and connects user interface 17, DCM 18, and ECU 10 with one another.

ECU 10 includes a central processing unit (CPU) 101, a memory 102, and an input/output port 103. ECU 10 controls each device such that vehicle 1 may achieve a desired state, based on an input of a signal from each sensor and a map and a program stored in the memory. Examples of main processing to be performed by ECU 10 in the first embodiment include calculating an index indicating the state of deterioration of battery 15. This processing will be described later.

Fee charging server 2 is configured to perform arithmetic processing described later based on data about the plurality of vehicles 1. Fee charging server 2 includes a battery information database 21 and a lease contract information database 22 that are each a database server, a communication module 23, an intra-server network 24, and an application server 20. It should be noted that fee charging server 2 corresponds to a “server” in accordance with the present disclosure.

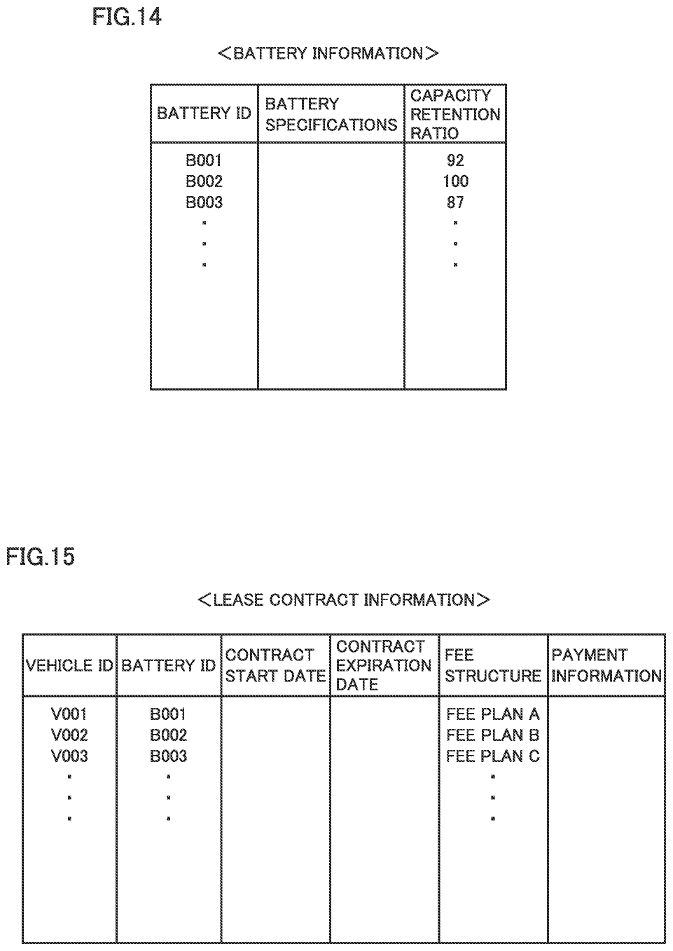

Battery information database 21 stores “battery information” (see FIG. 14), which is information indicating the state of battery 15 mounted on each vehicle 1. Lease contract information database 22 stores “lease contract information” (see FIG. 15), which is information obtained when the user makes a lease contract for battery 15 mounted on each vehicle 1.

Communication module 23 is configured to wirelessly bidirectionally communicate with DCM 18 mounted on vehicle 1. Communication module 23 is also configured to wirelessly communicate with smart phone 3 of the user of vehicle 1. It should be noted that communication module 23 corresponds to a “communication device” in accordance with the present disclosure.

Intra-server network 24 connects battery information database 21, lease contract information database 22, communication module 23, and application server 20 with one another.

As well as ECU 10, application server 20 includes a CPU 201, a memory 202, and an input/output port 203. Application server 20 performs a variety of arithmetic processing for leasing battery 15 to the user. Main processing to be performed by application server 20 is processing for managing a lease unit price U to be paid by the user for lease of battery 15. This processing will be described in detail later. It should be noted that application server 20 corresponds to a “processor” and a “fee charging device” in accordance with the present disclosure.

<Deterioration of Battery>

In battery lease system 100 configured as described above, battery 15 deteriorates as time elapses or as a travel distance of vehicle 1 increases. Hence, ECU 10 calculates an index indicating the state of deterioration of battery 15 to recognize the degree of progress of deterioration of battery 15. In the present embodiment, a capacity retention ratio Q of battery 15 is used as the index. Capacity retention ratio Q of battery 15 represents the ratio of a full charge capacity C of battery 15 at present to a full charge capacity C0 of battery 15 in an initial state (for example, at the time of manufacturing) (Q=C/C0).

Full charge capacity C0 in the initial state is already known from specifications of battery 15. On the other hand, full charge capacity C at present can be calculated as described below. For example, during external charging of vehicle 1, ECU 10 obtains, from monitoring unit 151, the OCV of battery 15 at the start of charging, the OCV of battery 15 at the end of charging, and a charging current amount ΔAh for battery 15 from the start of charging to the end of charging. Further, ECU 10 converts a difference between the OCV at the start of charging and the OCV at the end of charging into an SOC difference ΔSOC, with reference to an SOC-OCV curve stored beforehand in memory 102. Then, ECU 10 calculates full charge capacity C of battery 15 according to the following equation (1) indicating that the ratio of charging current amount ΔAh to SOC difference ΔSOC is equal to the ratio of full charge capacity C to the SOC difference=100%:

C=ΔAh/ΔSOC×100 (1)

The timing for calculating capacity retention ratio Q of battery 15 is not limited to during external charging of vehicle 1, and may be other than during external charging (such as during normal traveling of vehicle 1). For example, ECU 10 obtains information about temperature frequency distribution of battery 15, SOC frequency distribution of battery 15, a distance for which vehicle 1 can travel using electric power stored in battery 15 (so-called EV travel distance), a current load and charging current amount ΔAh for battery 15, and the like, and sequentially stores the information in memory 102. By determining the influence of these parameters on capacity retention ratio Q (the correlation between each parameter and capacity retention ratio Q) beforehand by a prior experiment, a decreased amount of capacity retention ratio Q can be calculated from each parameter described above, and capacity retention ratio Q at present can be calculated.

It should be noted that, as the index indicating the state of deterioration of battery 15, instead of or in addition to capacity retention ratio Q of battery 15, full charge capacity C (unit: Ah or Wh) of battery 15 may be used, or the EV travel distance (unit: km) of vehicle 1 may be used. These indices all indicate “full charge capacity” according to the present disclosure.

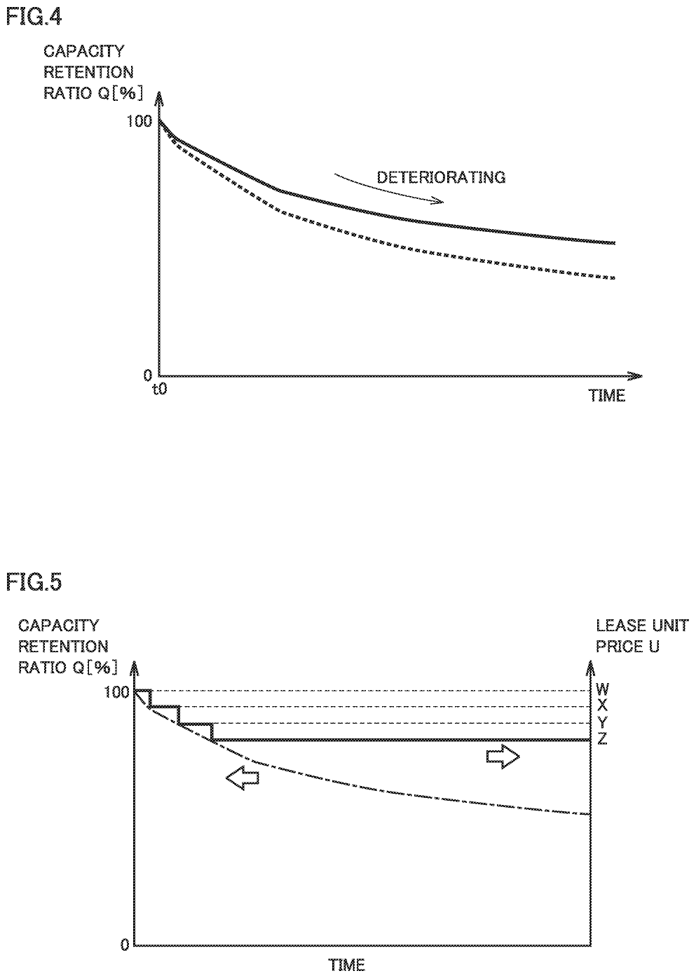

FIG. 4 is a view showing an example of a manner of deterioration of battery 15. In FIG. 4, the axis of abscissas represents an elapsed time from the initial state of battery 15. The axis of abscissas may be read as the travel distance of vehicle 1. The axis of ordinates represents capacity retention ratio Q of battery 15.

In FIG. 4, the manner in which capacity retention ratio Q of battery 15 mounted on certain vehicle 1 decreases is indicated by a solid line. However, the decrease rate (decreased amount per unit time) of capacity retention ratio Q may differ depending on the manner of using battery 15. For example, depending on the user's driving manner, battery 15 is charged/discharged with a large current, and the decrease rate of capacity retention ratio Q becomes faster, as indicated by a dotted line. Alternatively, as the environment where vehicle 1 is located has a higher temperature, the decrease rate of capacity retention ratio Q becomes faster.

As capacity retention ratio Q decreases, an EV traveling distance of vehicle 1 with the electric power stored in battery 15 decreases. Further, as capacity retention ratio Q decreases, the number of times of external charging (or a charging frequency) can increase, so that the user takes extra time and effort for external charging. Therefore, it can be said that the value of battery 15 decreases for the user in that the convenience of vehicle 1 decreases as capacity retention ratio Q decreases. However, for example, Japanese Patent Laying-Open No. 2002-291110 only describes that a lease fee is calculated in accordance with an amount of electric power charged/discharged to/from the battery and does not particularly consider the battery's deterioration in calculating the lease fee. Then, the user's dissatisfaction with the battery lease system tends to accumulate, and the user's satisfaction may be reduced.

Accordingly, in the first embodiment, a unit price for a fee for leasing battery 15 is determined according to capacity retention ratio Q of battery 15. The unit price for the fee for leasing battery 15 is a fee for leasing battery 15 for every fixed period of time or every fixed distance, and will also be abbreviated as a “lease unit price U” hereinafter. Lease unit price U corresponds to a “lending fee” according to the present disclosure.

<Lease Fee Structure>

As a fee structure for lease unit price U, a plurality of structures (plans) can be introduced as described below. In the first embodiment, by way of example, three fee plans of fee plans A, B and C are introduced.

FIG. 5 is a diagram for illustrating fee plan A. In FIG. 5, the axis of abscissas represents an elapsed time. The axis of ordinates on the left side represents capacity retention ratio Q of battery 15. The axis of ordinates on the right side represents lease unit price U for battery 15.

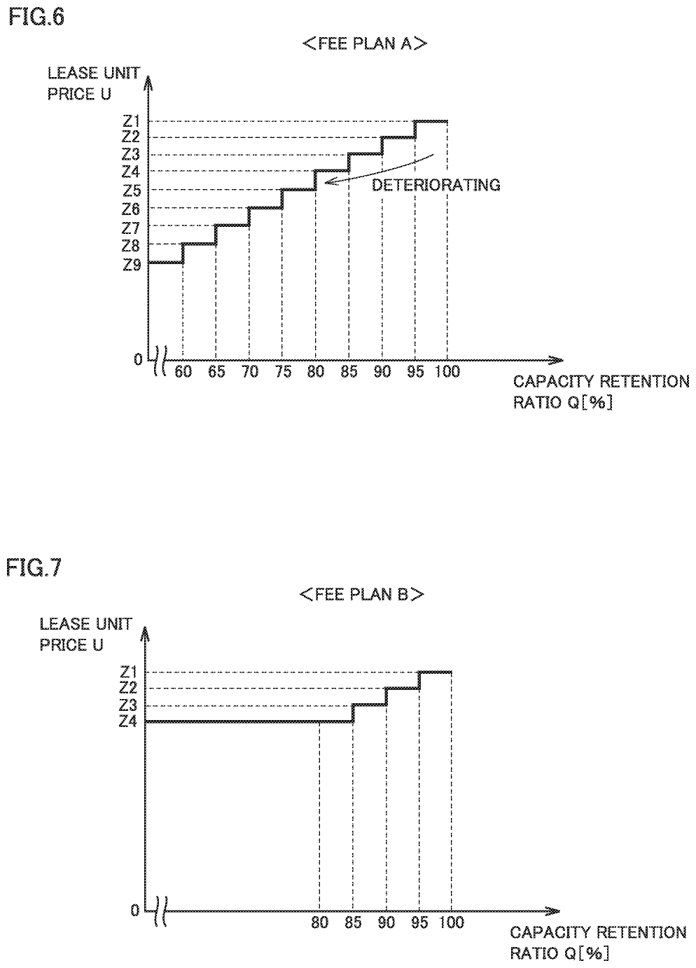

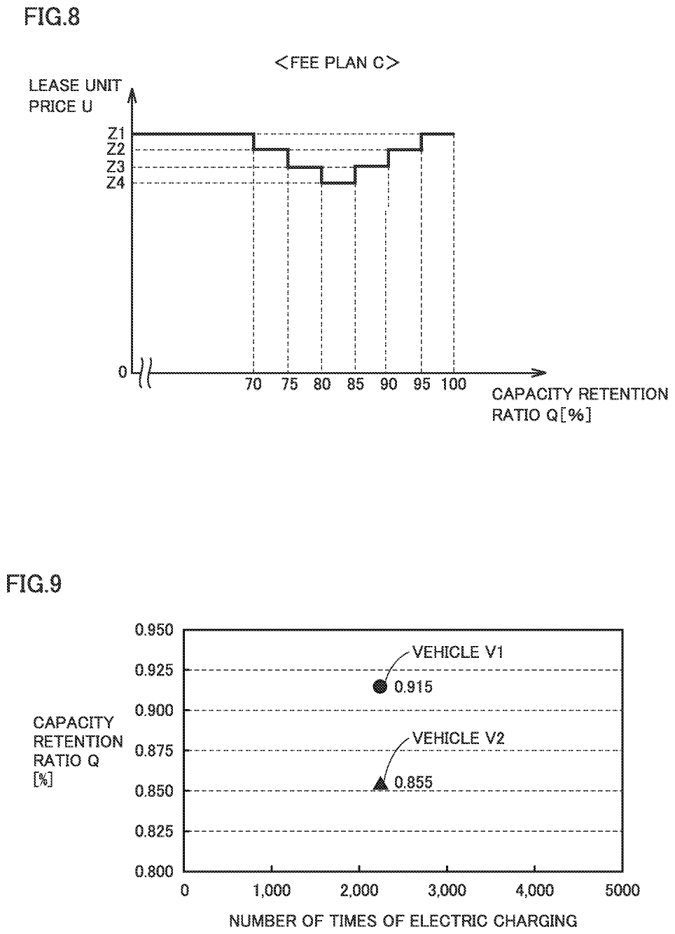

FIG. 6 is a diagram showing a relationship between capacity retention ratio Q of battery 15 and lease unit price U for battery 15 in fee plan A. In FIG. 6, and FIGS. 7 and 8 described later, the axis of abscissas represents capacity retention ratio Q of battery 15. The axis of ordinates represents lease unit price U for battery 15.

As shown in FIGS. 5 and 6, in fee plan A, lease unit price U decreases as capacity retention ratio Q of battery 15 decreases. More specifically, lease unit price U for a period of time with capacity retention ratio Q ranging from 100% to 95% is set to Z1. Lease unit price U for a period of time with capacity retention ratio Q ranging from 95% to 90% is set to Z2 lower than Z1 (Z1>Z2). Lease unit price U for a period of time with capacity retention ratio Q ranging from 90% to 85% is set to Z3 lower than Z2 (Z1>Z2>Z3). Lease unit price U after capacity retention ratio Q falls below 85% is set to Z4 lower than Z3 (Z1>Z2>Z3>Z4). After that, lease unit price U similarly degreases as capacity retention ratio Q decreases.

Thus, in fee plan A, as capacity retention ratio Q of battery 15 decreases, lease unit price U is determined to be lower. As capacity retention ratio Q of battery 15 decreases, an EV traveling distance of vehicle 1 decreases and the battery may also be charged more frequently, and accordingly, the value of battery 15 decreases. Accordingly, setting lease unit price U to be lower as capacity retention ratio Q decreases, as in fee plan A, can increase the user's satisfaction with lease unit price U.

FIG. 7 represents a relationship between capacity retention ratio Q of battery 15 and lease unit price U for the battery in fee plan B. FIG. 8 represents a relationship between capacity retention ratio Q of battery 15 and lease unit price U for the battery in fee plan C.

Referring to FIGS. 7 and 8, in fee plans B and C, as well as in fee plan A, at an early stage of deterioration of battery 15, lease unit price U becomes lower as capacity retention ratio Q of battery 15 decreases. In this example, lease unit price U for a period of time in which capacity retention ratio Q ranges from 100% to 95% is set to Z1. Lease unit price U for a period of time in which capacity retention ratio Q ranges from 95% to 90% is set to Z2 lower than Z1. Lease unit price U for a period of time in which capacity retention ratio Q ranges from 90% to 85% is set to Z3 lower than Z2. Lease unit price U for a period of time in which capacity retention ratio Q ranges from 85% to 80% is set to Z4 lower than Z3.

In fee plan A, lease unit price U continues to decrease even after capacity retention ratio Q falls below 80%. In contrast, in fee plan B, lease unit price U is maintained at Z4 after capacity retention ratio Q falls below 80%. Further, in fee plan C, lease unit price U for a period of time for which capacity retention ratio Q falls below 80% and reaches 75% is set to be higher than Z4, and it is set to Z3 in the example shown in FIG. 8. Further, lease unit price U for a period of time for which capacity retention ratio Q falls from 75% to 70% is set to Z2, and lease unit price U after capacity retention ratio Q falls below 70% is set to Z1.

When lease unit price U is maintained or increased while capacity retention ratio Q of battery 15 is decreasing and the value of battery 15 is decreasing, the user will pay a fee higher than an amount of money that is commensurate with the value of battery 15. Hence, the user is motivated to cancel (or stop) leasing vehicle 1 and return vehicle 1 to the lease company for example for exchanging the battery with a new battery. The lease company can thus collect battery 15 before it excessively deteriorates, and battery 15 collected can thus be recycled.

It should be noted that it is not essential to prepare three fee plans A, B and C as in the present embodiment, and only fee plan A may be prepared, or only fee plan B may be prepared, or only fee plan C may be prepared, or any two of the three plans may be prepared, or another plan may be prepared.

<Determine Lease Unit Price>

For example, according to Japanese Patent Laying-Open No. 2003-288539, a lease unit price is determined according to how many times a battery is charged or discharged (for example, see Japanese Patent Laying-Open No. 2003-288539, paragraphs [0018] to [0020]). In the first embodiment, in contrast, lease unit price U is determined according to capacity retention ratio Q of battery 15. How theses lease unit price determination methods are different will be described.

FIG. 9 is a diagram for illustrating a difference between capacity retention ratios of batteries of two vehicles V1 and V2. In FIG. 9, the horizontal axis represents the number of times of charging (the number of times of external charging). The vertical axis represents capacity retention ratio Q of each battery.

FIG. 9 shows a battery's capacity retention ratio when two vehicles V1 and V2 (vehicles having the same configuration as vehicle 1 shown in FIG. 3) of the same vehicle type are externally charged the same number of times when a period of time (in this example, 36 months) has elapsed after they were manufactured. From FIG. 9, it can be seen that even if the same period of time has elapsed after they were manufactured, and they are also electrically charged the same number of times, the battery's capacity retention ratio can significantly vary. Reasons therefor include an effect of the battery's SOC, an effect of the battery's temperature, and an effect of the battery's load, as will be described below.

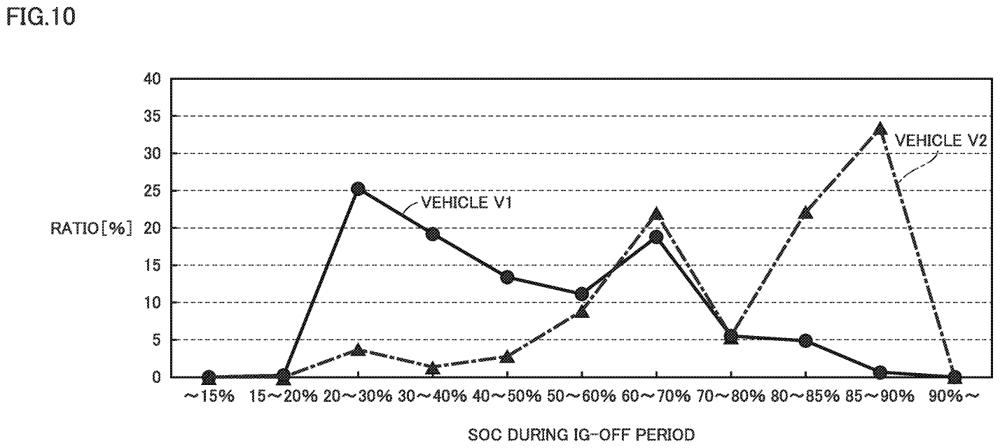

FIG. 10 is a diagram for illustrating an effect of the battery's SOC on capacity retention ratio Q. In FIG. 10, the horizontal axis represents the battery's SOC for a period of time in which vehicles V1 and V2 are each ignition-off (an IG-OFF period). The vertical axis represents a ratio of an IG-OFF period for each SOC to the entire IG-OFF period.

A high ratio of the IG-OFF period in a high SOC state means that the battery has been left in a state close to the fully charged state for a long period of time. In the example shown in FIG. 10, vehicle V2 has a higher ratio of being left in a high SOC state than vehicle V1. Thus, it is believed that capacity retention ratio Q of the battery of vehicle V2 is more easily decreased.

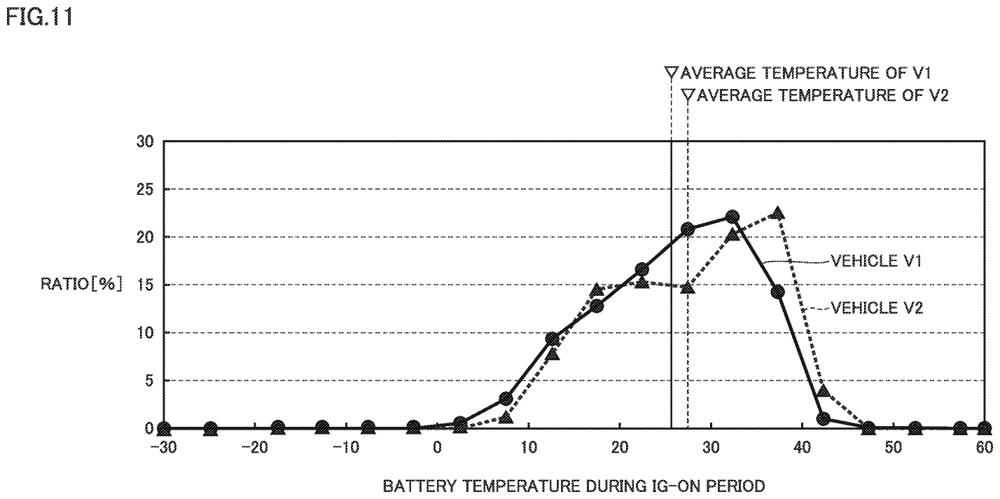

FIG. 11 is a diagram for illustrating an effect of the battery's temperature on capacity retention ratio Q. In FIG. 11, the horizontal axis represents the battery's temperature for a period of time for which vehicles V1 and V2 are each ignition-on (IG-ON). The vertical axis represents a ratio of an IG-ON period at each temperature to the entire IG-ON period.

The higher a ratio of high temperature during the IG-ON period is, the more easily the battery deteriorates. In the example shown in FIG. 11, vehicle V2 has a higher average temperature than vehicle V1. It is believed that this also makes it easier to decrease capacity retention ratio Q of the battery of vehicle V2.

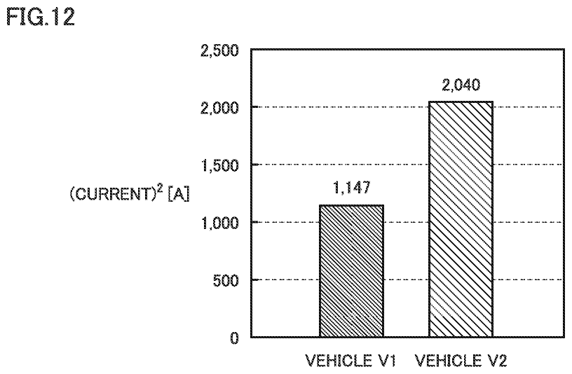

FIG. 12 is a diagram for illustrating an effect of the battery's load on capacity retention ratio Q. In FIG. 12, a value obtained by squaring a current charged/discharged to/from the battery is represented as a load of the battery. As a vehicle is rapidly accelerated and/or decelerated more frequently, a current charged/discharged to/from the battery increases, and the battery's deterioration tends to progress. In the example shown in FIG. 12, vehicle V2 has a larger cumulative value of a current than vehicle V1. This is also considered to be one of the factors that make it easier to decrease capacity retention ratio Q of the battery of vehicle V2.

Thus, a degree of progress of deterioration of battery 15 is not determined only by how many times battery 15 is charged/discharged but can also be affected by various factors such as battery 15's SOC, temperature, and current. Accordingly, in determining lease unit price U for battery 15, it is desirable to use a parameter related to battery 15's full charge capacity and allowing a degree of progress of deterioration of battery 15 to be appropriately reflected therein, or capacity retention ratio Q.

<Flow of Lease of Battery>

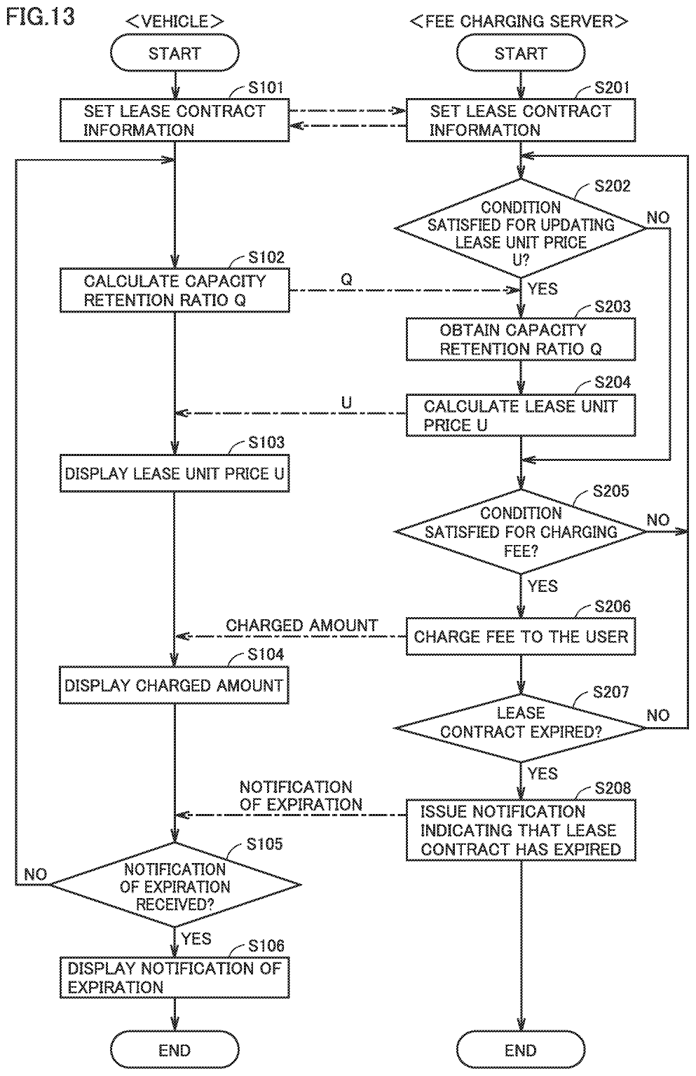

FIG. 13 is a flowchart showing processing related to lease of the battery in the first embodiment. In FIG. 13, a series of processings to be performed by ECU 10 of vehicle 1 is shown on the left side of the drawing, and a series of processings to be performed by application server 20 of fee charging server 2 is shown on the right side of the drawing. It should be noted that, in the following, for the sake of simplification, the subject that performs the step to be performed by ECU 10 may be described as vehicle 1, and the subject that performs the step to be performed by application server 20 may be described as fee charging server 2. Although each step is implemented by software processing by vehicle 1 (ECU 10) or fee charging server 2 (application server 20), it may be implemented by dedicated hardware (electric circuitry) fabricated within vehicle 1 or fee charging server 2.

Referring to FIGS. 2, 3, and 13, the series of processings to be performed by vehicle 1 shown on the left side of the drawing is performed for example when a predetermined condition is satisfied (for example, when the user of vehicle 1 performs an operation indicating that the user wants to lease vehicle 1, using user interface 17, which is a touch panel-equipped monitor or the like). The series of processings to be performed by fee charging server 2 shown on the right side of the drawing is periodically performed each time a predetermined control cycle elapses, for example.

First, vehicle 1 and fee charging server 2 perform processing for making a lease contract for vehicle 1 by mutually communicating required information (S101, S201). More specifically, in fee charging server 2, battery information is stored in battery information database 21 and lease contract information is stored in lease contract information database 22, as described above.

FIG. 14 is a conceptual view showing an example of a data structure of the battery information. Referring to FIG. 14, the battery information includes, for example, an identification number for identifying each battery 15 (battery ID), information about specifications of each battery 15 (for example, such as the manufacturer, the model number, the number of modules connected in series/parallel and connection relation thereof, the maximum allowable voltage, the maximum allowable current, and the operating temperature range of each battery 15) (battery specifications), and information about capacity retention ratio Q of each battery 15. The information about capacity retention ratio Q is updated as appropriate based on information received for example during external charging of vehicle 1 (or a vehicle on which battery 15 has been mounted, when battery 15 is a used battery).

FIG. 15 is a conceptual view showing an example of a data structure of the lease contract information. Referring to FIG. 15, the lease contract information includes, for example, an identification number for identifying each vehicle 1 (vehicle ID), an battery ID, information about a start date of the lease contract, information about an expiration date of the lease contract, information about a fee structure of the lease contract, and payment information of the user. The information about the fee structure is information that defines the relation between capacity retention ratio Q and lease unit price U, and specifically is information such as fee plan A, fee plan B, or the like. The payment information of the user is registered information such as a bank account, a credit card, or the like of the user for paying a lease fee for vehicle 1.

Returning to FIG. 13, the user inputs his or her desired contract start date and contract expiration date, and selects a desired fee structure (fee plan). The user also registers his or her payment information. Then, vehicle 1 transmits each information described above input by the user to fee charging server 2, together with its vehicle ID and battery ID. Based on the information from vehicle 1, fee charging server 2 registers the lease contract information for a new user, or updates the lease contract information for an already registered user. When steps S101 and S201 are normally completed, vehicle 1 for example receives from fee charging server 2 authentication which permits starting to use vehicle 1, and leasing vehicle 1 is thus started.

In S202, fee charging server 2 determines whether a condition for updating lease unit price U is satisfied. For example, it is determined that the condition for updating lease unit price U is satisfied whenever a predetermined period of time elapses since using vehicle 1 was started (or it may be determined that the condition is satisfied whenever the predetermined period of time elapses since a lease contract for the battery was made or last updated). Alternatively, it may be determined that the condition for updating lease unit price U is satisfied whenever vehicle 1 travels a predetermined distance since using vehicle 1 was started.

When the condition for updating lease unit price U is satisfied (YES in S202), fee charging server 2 requests vehicle 1 to transmit capacity retention ratio Q of battery 15 mounted on vehicle 1 (not shown). Vehicle 1 calculates capacity retention ratio Q of battery 15 in response to the request received from fee charging server 2, and transmits the calculation result to fee charging server 2 (S102). Thus, fee charging server 2 obtains capacity retention ratio Q of battery 15 (S203).

It should be noted, however, that fee charging server 2 may periodically obtain capacity retention ratio Q of battery 15 irrespective of whether lease unit price U is updated. Then, whenever capacity retention ratio Q decreases by a specified amount (5% in the above-described example), fee charging server 2 may proceed to S204, as described below.

In S204, fee charging server 2 calculates lease unit price U according to a fee plan (fee plan A, B or C) for which the user has made a contract, and fee charging server 2 transmits the calculation result to vehicle 1 via communication module 23. How lease unit price U is calculated has been described in detail with reference to FIGS. 5 to 8, and accordingly, will not be described repeatedly. Vehicle 1 receives lease unit price U from fee charging server 2 and provides (e.g., displays) it to the user via user interface 17 (S103). This information may be provided to smartphone 3 of the user. Thus, the user can obtain a lease unit price. Note, however, that step S103 is not essential. When the condition for updating lease unit price U is not satisfied (NO in S202), steps S203 and S204 are skipped.

In S205, fee charging server 2 determines whether a condition for charging the user (a fee charging condition) is satisfied. As an example, a fee charging condition is satisfied once a month on a predetermined date (for example, the last day of every month). Alternatively, the fee charging condition is satisfied whenever vehicle 1 travels a predetermined distance (for example, 1000 km). Once the fee charging condition has been satisfied (YES in S205), fee charging server 2 proceeds to S206.

In S206, fee charging server 2 charges lease unit price U to the user by referring to the user's payment information (information such as the user's registered account and credit card) included in the lease contract information. The charged amount is transmitted from fee charging server 2 to vehicle 1 via communication module 23 and displayed on user interface 17 (S104). Note that when the charging is actually done can be appropriately set according to the user's payment condition(s) and the like. When the charging condition is not satisfied (NO in S205), the process returns to S202.

Thereafter, fee charging server 2 determines whether the lease contract set previously in S201 has expired (S207). For example, it is determined that the lease contract has expired when the expiration date of the lease contract has arrived (or it may be so determined a few days to a few weeks before the expiration date of the lease contract for leeway). When a lease contract is made based on how much distance vehicle 1 travels, it is determined that the lease contract expires once vehicle 1 has traveled a predetermined distance.

When the lease contract has not expired (NO in S207), fee charging server 2 returns the process to S202. Thus, steps S202 to S207 are repeatedly performed until the lease contract expires. Once the lease contract has expired (YES in S207), fee charging server 2 notifies vehicle 1 that the lease contract has expired (S208). When vehicle 1 receives the notification that the lease contract has expired from fee charging server 2 (YES in S105), vehicle 1 provides (e.g., displays) the notification to the user (S106). This can serves as an occasion for the user to return vehicle 1 to the lease company.

As described above, in the present embodiment, fee charging server 2 takes deterioration of battery 15 into consideration and accordingly, determines lease unit price U to be lower as capacity retention ratio Q of battery 15 decreases. That is, fee charging server 2 reflects a degree of progress of deterioration of battery 15 in lease unit price U. As a result, the user will pay a fee commensurate with performance (an EV traveling distance or a charging frequency) that vehicle 1 can exhibit depending on battery 15. Thus, according to the present embodiment, the user can be less likely to be dissatisfied with leasing vehicle 1 and reduction of the user's satisfaction can also be suppressed.

### Second Embodiment

A second embodiment will describe a configuration of providing information about when lease unit price U of battery 15 will be changed and information for increasing an EV distance of vehicle 1, from fee charging server 2 to vehicle 1 (user).

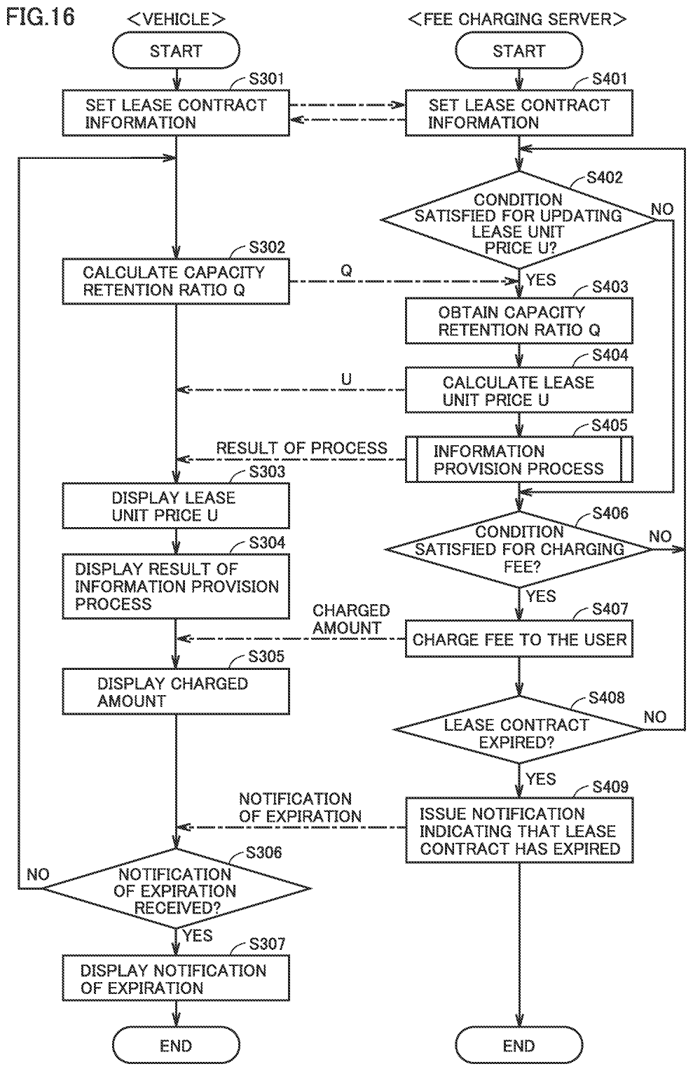

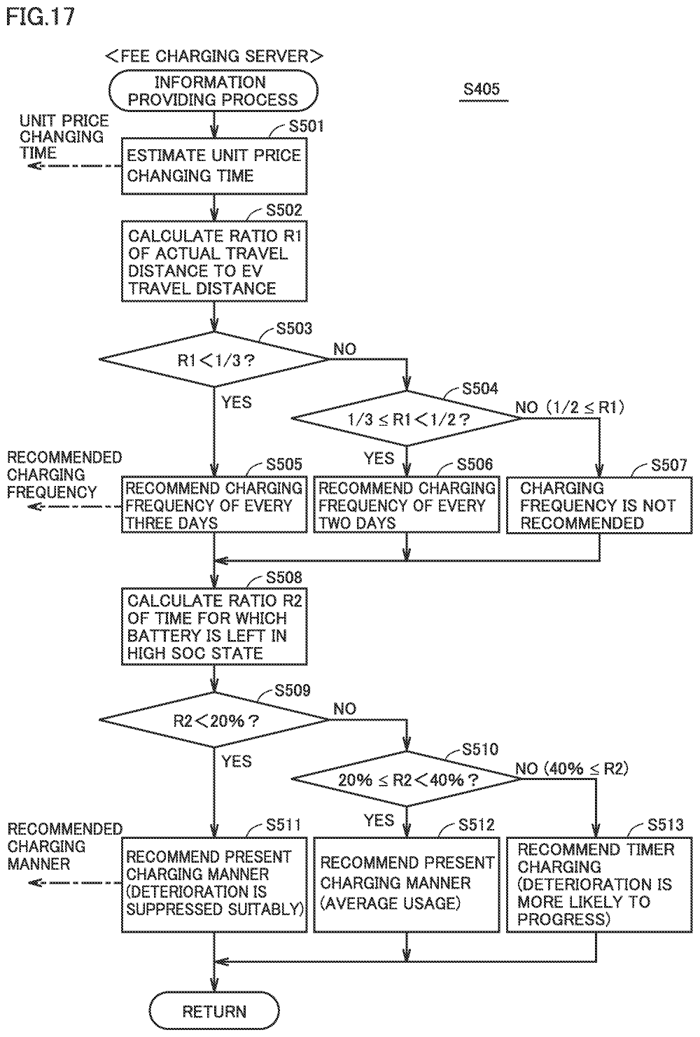

FIG. 16 is a flowchart showing processing related to lease of the battery in the second embodiment. Referring to FIG. 16, this flowchart is different from the flowchart in the first embodiment (see FIG. 13) in that it further includes an information providing process performed in S405 and a process (S304) for displaying a result of the information providing process. Since the processings other than that are the same as the corresponding processings in the first embodiment, the description thereof is not repeated.

In S302, vehicle 1 calculates capacity retention ratio Q of battery 15, and transmits the result of calculation to fee charging server 2. Fee charging server 2 obtains capacity retention ratio Q of battery 15 (S403). Furthermore, fee charging server 2 calculates lease unit price U depending on a fee plan for which a contract is made with the user, and fee charging server 2 transmits the calculation result to vehicle 1 (S404). Furthermore, fee charging server 2 performs the information providing process and transmits to vehicle 1 the information obtained as a result thereof (S405). The information providing process will more specifically be described hereinafter.

It should be noted that the timing for performing information providing processing is not limited to upon reception of capacity retention ratio Q. Information providing processing may be performed each time a predetermined period elapses (such as per day, per week, per month, or per half a year), for example. The destination of the information obtained by information providing processing is not limited to vehicle 1, and may be smart phone 3 of the user. Further, the above information may be provided to the user by a web service that can be viewed by the user using a personal computer (PC) at a house or the like.

FIG. 17 is a flowchart showing an example of information providing processing. Although not shown, information about the SOC of battery 15 is periodically transmitted from vehicle 1 to fee charging server 2.

Referring to FIG. 17, in S501, fee charging server 2 estimates when leasing a vehicle at the current lease unit price U will end (that is, when lease unit price U will be changed). Hereinafter, when lease unit price U will be changed will also be referred to as a “unit price changing time.” The unit price changing time can be estimated as described below, for example.

Fee charging server 2 has predicted curve Lpre representing a typical manner in which capacity retention ratio Q of battery 15 decreases in memory 202 beforehand (see FIG. 4). Fee charging server 2 corrects predicted curve Lpre based on actual capacity retention ratio Q received from vehicle 1. For example, when actual capacity retention ratio Q at a certain time is lower than capacity retention ratio Q on predicted curve Lpre at the same time, fee charging server 2 corrects predicted curve Lpre downward (in a direction in which the future decrease rate of capacity retention ratio Q increases). Conversely, when actual capacity retention ratio Q is higher than capacity retention ratio Q on predicted curve Lpre in comparison at the same time, fee charging server 2 corrects predicted curve Lpre upward (in a direction in which the future decrease rate of capacity retention ratio Q decreases). Then, fee charging server 2 estimates a time when capacity retention ratio Q will decrease by a specified amount (i.e., a unit price changing time), based on corrected predicted curve Lpre. Fee charging server 2 transmits the estimated unit price changing time to vehicle 1.

The processings in S502 to S507 are processing for providing vehicle 1 with advice about a recommended charging frequency of battery 15. In S502, fee charging server 2 calculates a ratio R1 of the actual value of the travel distance per day of vehicle 1 to the EV travel distance of vehicle 1.

The EV travel distance of vehicle 1 is a distance for which vehicle 1 can travel using power stored in battery 15 (if vehicle 1 includes an engine, without operating the engine). As the EV travel distance of vehicle 1, a specification value (catalog value) based on the capacity of battery 15 and the power efficiency of vehicle 1 may be used, or an actual value measured in vehicle 1 may be used. As the actual value of the travel distance per day of vehicle 1, for example, an average value of travel distances per day in the past can be used. Alternatively, a travel distance per day in the past under similar conditions, such as the day of the week and outside air temperature, may be used.

Fee charging server 2 compares calculated ratio R1 with two determination values that are less than 1 (in this example, ⅓ and ½). When ratio R1 is less than 1, the actual value of the travel distance per day of vehicle 1 is shorter than the EV travel distance of vehicle 1. Accordingly, traveling of vehicle 1 can be entirely performed by EV traveling. In addition, even after traveling is entirely performed by EV traveling, the power stored in battery 15 may have a margin.

Generally, when the battery is left for a long time with the SOC being higher than a reference value (for example, 80%), deterioration thereof is more likely to progress accordingly. Therefore, in order to suppress deterioration of battery 15, it is desirable not to increase the charging frequency of battery 15 excessively. This is because, by not performing charging of battery 15 intentionally when the power stored in battery 15 has a margin, it is possible to avoid battery 15 from having a high SOC.

When ratio R1 is less than ⅓ (YES in S503), fee charging server 2 advances the processing to S505. In S505, fee charging server 2 provides vehicle 1 with information that the recommended charging frequency is every three days or so, under typical use of vehicle 1 by the user.

Further, when ratio R1 is more than or equal to ⅓ and less than ½ (YES in S504), fee charging server 2 advances the processing to S506. In S506, fee charging server 2 provides vehicle 1 with information that the recommended charging frequency is every two days or so, under typical use of vehicle 1 by the user.

On the other hand, when ratio R1 is more than or equal to ½ (NO in S504), fee charging server 2 does not transmit a value serving as a measure of the recommended charging frequency to vehicle 1. By charging battery 15 every day when ratio R1 is relatively close to 1, such as when ratio R1 is more than or equal to ½, it is possible to prevent the power in battery 15 from being depleted during traveling of vehicle 1.

The processings in subsequent S508 to S513 are processing for providing vehicle 1 with advice about a recommended charging manner of battery 15. Specifically, fee charging server 2 determines whether timer charging is preferable or normal charging is preferable (or how to combine these chargings) as a charging manner of battery 15 in vehicle 1, from the viewpoint of suppressing progress of deterioration of battery 15, and transmits the result of determination to vehicle 1.

It should be noted that timer charging is a charging manner that charges battery 15 according to a time schedule set for example by the user. Normal charging is a charging manner that starts charging of battery 15 without following a time schedule (so to speak, depending on the situation), for example when charging cable 4 is connected to vehicle 1 to allow battery 15 to be charged.

As described above, in order to suppress deterioration of battery 15, it is desirable to shorten the time for which battery 15 is left in a high SOC state as much as possible. Therefore, in S508, fee charging server 2 calculates a ratio R2 of the time for which battery 15 is left in a high SOC state to a total use time of battery 15. The length of the total use time of battery 15 can be obtained by measuring an elapsed time from manufacturing of battery 15 (which may be manufacturing of vehicle 1) to the present. The time for which battery 15 is left in a high SOC state can be calculated by calculating a cumulative value of the time for which battery 15 is left in a high SOC state to the present. Fee charging server 2 compares calculated ratio R2 with two determination values (in this example, 20% and 40%).

When ratio R2 is less than 20% (YES in S509), fee charging server 2 advances the processing to S511. In S511, fee charging server 2 provides vehicle 1 with information that it is desirable to continue the present charging manner, because progress of deterioration of battery 15 can be suppressed suitably (at a high level) by the charging manner of battery 15 in vehicle 1 employed up to the present (proper use of timer charging and normal charging).

Further, when ratio R2 is more than or equal to 20% and less than 40% (YES in S510), fee charging server 2 advances the processing to S512. Also in S512, fee charging server 2 provides vehicle 1 with information that it is desirable to continue the present charging manner in vehicle 1. This is because progress of deterioration of battery 15 can be suppressed to a certain degree (at an average level) by the charging manner of battery 15 employed up to the present.

On the other hand, when ratio R2 is more than or equal to 40% (NO in S510), the time for which battery 15 is left in a high SOC state is too long, and deterioration of battery 15 is more likely to progress. Therefore, fee charging server 2 advances the processing to S513, and provides vehicle 1 with information that it is desirable to further utilize timer charging. In the case of normal charging, a period from when charging of battery 15 is completed to when vehicle 1 starts traveling can become long. During this period, battery 15 is left in a high SOC state, and thus deterioration of battery 15 is more likely to progress. In contrast, when timer charging is utilized to set a time schedule such that charging of battery 15 is completed immediately before vehicle 1 starts traveling, the time for which battery 15 is left in a high SOC state becomes shorter, as compared with a case where timer charging is not utilized. Thus, progress of deterioration of battery 15 can be suppressed. When any of the processings in S511 to S513 ends, fee charging server 2 returns the processing to the flowchart shown in FIG. 16.

As described above, in the second embodiment, information about when leasing at the current lease unit price U will end and lease unit price U will be changed (corresponding to the “first information” in accordance with the present disclosure) is provided, or information about the recommended charging frequency or the recommended charging manner for suppressing deterioration of battery 15 (corresponding to the “second information” in accordance with the present disclosure) is provided, from server 2 to the user. Although the description has been given of a case where three types of information are provided, only any one type or two types of information may be provided.

In the battery lease system in accordance with the second embodiment, a degree of deterioration of battery 15 can be reflected in lease unit price U. However, it is difficult for the user to recognize the degree of progress of deterioration of battery 15, and when lease unit price U will be changed is unclear, the user may be dissatisfied. Accordingly, providing the user beforehand with the information about when lease unit price U will be changed can prevent a so-called surprise situation for the user in which lease unit price U will suddenly be changed. Thereby, user satisfaction can be improved.

In addition, by providing the user with the information about the recommended charging frequency or the recommended charging manner, the user can avoid setting the charging frequency of battery 15 to be unnecessarily high, or can utilize timer charging to charge battery 15. Thereby, progress of deterioration of battery 15 can be suppressed, which can prevent lease unit price U from rising and reduce the fee for leasing battery 15. As a result, user satisfaction can be improved.

Although the embodiments of the present disclosure have been described, it should be understood that the embodiments disclosed herein are illustrative and non-restrictive in every respect. The scope of the present disclosure is defined by the scope of the claims, and is intended to include any modifications within the scope and meaning equivalent to the scope of the claims.

What is claimed is:

1. A server that manages a lending fee paid by a user for lending a battery mountable on a vehicle for traveling, comprising:
a communication device that communicates with the vehicle; and
a processor that collects the battery's full charge capacity from the vehicle via the communication device and determines the lending fee according to the collected full charge capacity.

2. The server according to claim 1, further comprising a fee charging device that charges the user with the lending fee determined by the processor after the battery is lent for a predetermined period of time or after the vehicle travels a predetermined distance.

3. The server according to claim 1, wherein the processor provides the user via the communication device with the lending fee determined by the processor.

4. The server according to claim 1, wherein the processor decreases the lending fee as the battery's full charge capacity decreases.

5. The server according to claim 4, wherein the processor keeps the lending fee after the battery's full charge capacity falls below a predetermined amount.

6. The server according to claim 4, wherein when the battery's full charge capacity falls below a predetermined amount, the processor sets the lending fee to be higher than when the battery's full charge capacity exceeds the predetermined amount.

7. The server according to claim 1, wherein the processor provides the user with first information about when the lending fee will be changed before the lending fee is changed.

8. The server according to claim 1, wherein the processor provides the user with second information for increasing an electric vehicle (EV) travel distance for which the vehicle can travel using power stored in the battery, determined based on a status of use of the battery by the user.

9. The server according to claim 8, wherein the second information is information about a recommended charging frequency of the battery, determined based on a travel distance per day of the vehicle and the EV travel distance.

10. The server according to claim 8, wherein the second information is information about a recommended charging manner of the battery including timer charging performed according to a time schedule, determined based on a time for which the battery is left with an SOC of the battery being higher than a reference value.

11. A battery lending method for lending to a user a battery mountable on a vehicle for travelling, the method comprising:
collecting the battery's full charge capacity from the vehicle; and
according to the full charge capacity collected, determining a lending fee to be paid by the user for lending the battery.
